(19) United States
(12) Patent Application Publication
(10) Pub. No.: US 2025/0155941 A1
(43) Pub. Date: May 15, 2025

(54) ENERGY SOURCE FOR MEMORY DEVICE

(71) Applicant: SMART Modular Technologies, Inc., Newark, CA (US)

(72) Inventors: Jinying Shen, San Ramon, CA (US); Torry Steed, Poway, CA (US); Andrew Mills, Coto de Caza, CA (US)

(21) Appl. No.: 18/389,247

(22) Filed: Nov. 14, 2023

(51) Int. Cl. G06F 1/3234

(52) U.S. Cl. CPC G06F 1/3275

(57) ABSTRACT

An energy source for a memory device is disclosed. In particular, a memory device such as an insertable memory card may include a detachable portion that has an energy source positioned thereon. The junction between the primary portion and the detachable portion includes sufficient conductors to convey power from the energy source as well as any needed control signals. In an exemplary aspect, the detachable portion is positioned relative to the primary portion such that the detachable portion may be readily removed while the memory device is installed in a computing device. By providing a detachable energy source, the energy source may readily be replaced in the event of failure without having to replace the entirety of the memory device. Such flexibility may save time, money, and otherwise simplify design requirements.

### BACKGROUND

### I. Field of the Disclosure

The technology of the disclosure relates generally to providing an energy source for memory devices, such as a battery on a serially attached memory card.

### II. Background

Computing devices abound in modern society. The prevalence of computers is driven in part by the many functions that are now enabled on such devices. Increased processing capabilities in such devices means that computing devices have evolved from simple mathematical processing devices into sophisticated multi-function devices, thus enabling enhanced user experiences. With the advent of the myriad functions available to such devices, there has been an increased need for memory to house software operating on the computing device as well as memory to store active processes as they are executed.

Various types of memory exist, including non-volatile, which acts as persistent memory and may store data through a power loss or power down event, and volatile, which, in general, does not store data through a power loss or power down event. More recently, there have been efforts to create hybrid memory devices that will move data within volatile memory into non-volatile memory in the event of power loss. Such hybrid devices have an energy source such as a battery or capacitor, which will provide power long enough to copy the data from the volatile memory to non-volatile memory, thereby preventing loss of data. However, such energy devices have an expected life cycle. Replacement of such energy devices provides room for innovation.

### SUMMARY

Aspects disclosed in the detailed description include an energy source for a memory device. In particular, a memory device such as an insertable memory card may include a detachable portion that has an energy source positioned thereon. The junction between the primary portion and the detachable portion includes sufficient conductors to convey power from the energy source as well as any needed control signals. In an exemplary aspect, the detachable portion is positioned relative to the primary portion such that the detachable portion may be readily removed while the memory device is installed in a computing device. By providing a detachable energy source, the energy source may readily be replaced in the event of failure without having to replace the entirety of the memory device. Such flexibility may save time and money and otherwise simplify design requirements.

In this regard in one aspect, a computing device is disclosed. The computing device includes a computer housing delimiting one or more bays on a first face and a memory device. The memory device includes a memory housing configured to comply with a published form factor and fit within the one or more bays, a primary portion positioned within the memory housing, the primary portion comprising at least one memory element and a detachable portion selectively coupled to the primary portion and when coupled to the primary portion, the detachable portion is positioned within the memory housing and when the detachable portion is detached from the primary portion, the detachable portion may be removed from the memory housing.

In another aspect, a memory device is disclosed. The memory device includes a housing configured to comply with a published form factor and a primary portion positioned within the housing, the primary portion comprising at least one memory element. The memory device further includes a detachable portion selectively coupled to the primary portion, and when coupled to the primary portion, the detachable portion is positioned within the housing, and when the detachable portion is detached from the primary portion, the detachable portion may be removed from the housing.

### BRIEF DESCRIPTION OF THE DRAWINGS

FIG. 1 is a perspective side elevation view of a computing device with a bank of memory devices accessible through a face, including one memory device being inserted;

FIG. 2A is a top plan view of a memory device;

FIG. 2B is a block diagram of the memory device of FIG. 2A;

FIG. 3 is a top plan view of a memory device, according to an exemplary aspect of the present disclosure with a removable energy source;

FIGS. 4A-4C illustrate various mechanical mechanisms to trigger removal of the removable energy source;

FIGS. 5A and 5B illustrate alternate placements for the removable energy source on a memory device;

FIG. 6 illustrates an alternate memory device that also has a removable energy source;

FIG. 7 is a block diagram of a memory device with a removable energy source in a computing device; and

FIG. 8 is a flowchart showing the ejection and reinsertion of the removable energy source.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that although the terms first, second, etc. may be used herein to describe various elements, these elements should not be limited by these terms. These terms are only used to distinguish one element from another. For example, a first element could be termed a second element, and similarly, a second element could be termed a first element without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element, or intervening elements may also be present. In contrast, when an element is referred to as being “directly on” or extending “directly onto” another element, no intervening elements are present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, no intervening elements are present. It will also be understood that when an element is referred to as being “connected” or “coupled” to another element, it can be directly connected or coupled to the other element, or intervening elements may be present. In contrast, when an element is referred to as being “directly connected” or “directly coupled” to another element, no intervening elements are present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Before addressing aspects of the present disclosure, a definition is offered. As used herein, the term double data rate or DDR is an industry term that means transferring data on the rising and falling edge of the clock signal, allowing for faster data transfer rates as compared to single data rate (SDR), which is only clocked on one edge of the clock (either rising or falling edge). As noted, DDR and SDR are terms used pervasively within the memory and computer industries.

Aspects disclosed in the detailed description include an energy source for a memory device. In particular, a memory device such as an insertable memory card may include a detachable portion that has an energy source positioned thereon. The junction between the primary portion and the detachable portion includes sufficient conductors to convey power from the energy source as well as any needed control signals. In an exemplary aspect, the detachable portion is positioned relative to the primary portion such that the detachable portion may be readily removed while the memory device is installed in a computing device. By providing a detachable energy source, the energy source may readily be replaced in the event of failure without having to replace the entirety of the memory device. Such flexibility may save time, money and otherwise simplify design requirements.

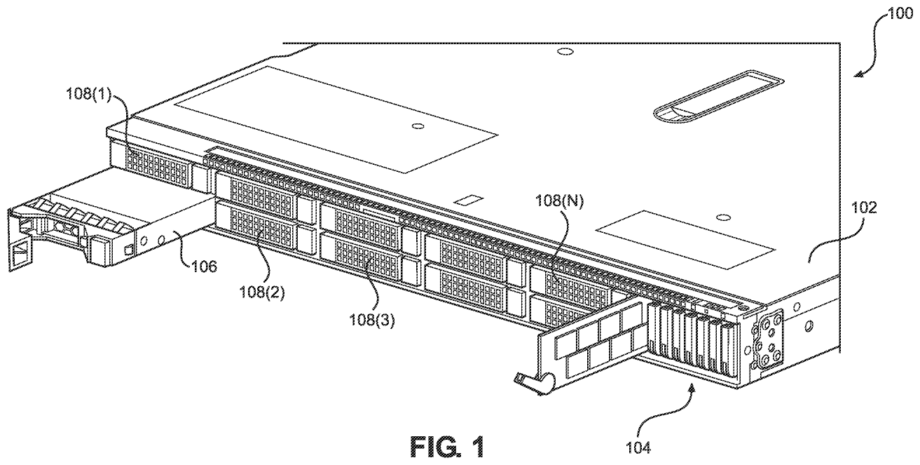

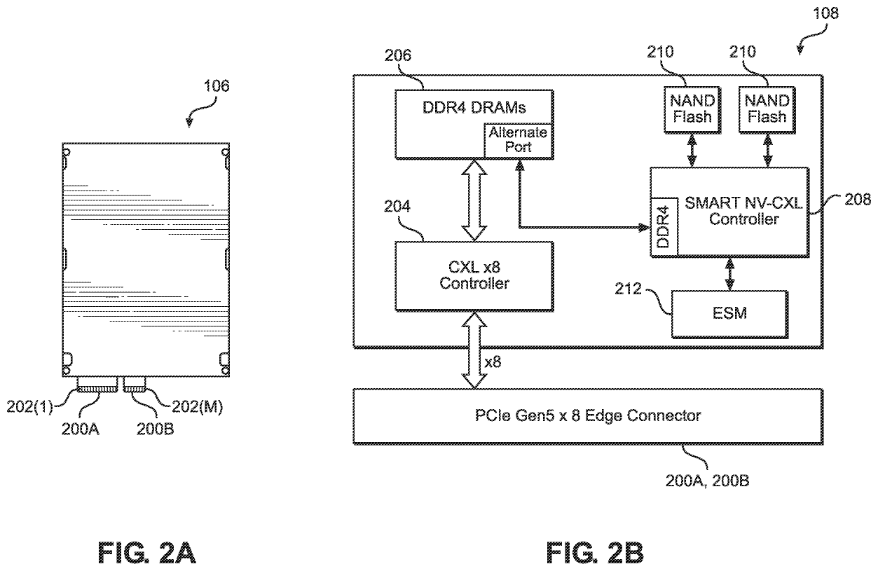

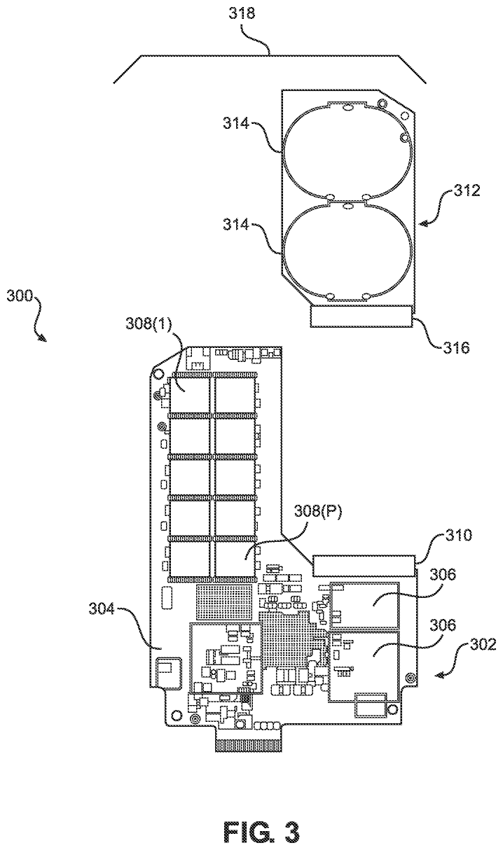

Before addressing particulars of the present disclosure, a brief overview of existing computing devices and how current memory devices may be used therein is provided with reference to FIGS. 1-2B. A discussion of exemplary aspects of the present disclosure begins below with reference to FIG. 3.

In this regard, FIG. 1 is a perspective side elevational view of a computing device 100 that may include a housing 102 with a face 104. In some aspects, the face 104 is referred to as a front face, but such terminology is not intended to be limiting. As illustrated, the computing device 100 may be a server blade that may be mounted in a server rack (not shown) or the like, while the “front face” is the face 104 that is accessible when a user is facing the rack as is well understood. While such server blades are specifically contemplated, the present disclosure is not limited to such computing devices.

With further reference to FIG. 1, the face 104 may include apertures configured to receive a memory device housing 106. A plurality of memory devices 108(1)-108(N), each with a respective memory device housing 106, may be inserted into the apertures. While not shown, the apertures provide access to bays that follow a published form factor and include connections that allow memory elements in the memory devices 108(1)-108(N) to be accessed by an internal processor or the like.

FIGS. 2A-2B provide additional details about a memory device housing 106 and the contents of a memory device 108, respectively. In particular, the housing 106, illustrated in FIG. 2A, may be generally rectangular and conform to a form factor such as the E3.S form factor. The housing 106 may include connectors 200A, 200B with conductors 202(1)-202(M) thereon that allow signals to be passed into and out of memory elements within the memory device 108.

FIG. 2B provides additional details about the elements within the memory device 108. In particular, the connectors 200A, 200B may couple to a control circuit 204 such as a Compute eXpress Link (CXL) controller. The control circuit 204 may be coupled to one or more volatile memory elements 206, which may, in an exemplary aspect, be dynamic random-access memory (DRAM) that conforms to dual data rate 4 (DDR4) signaling protocols. While DDR4 is specifically contemplated, other DDR protocols (e.g., DDR5, DDR6, etc.) may also be used without departing from the present disclosure. The memory elements 206 may be coupled to a second control circuit 208 that works with non-volatile memory elements 210, which may be NAND FLASH memory elements. Further, the second control circuit 208 may be coupled to an energy source module (ESM) 212. In exemplary aspects, the ESM 212 is a battery but could be a bank of capacitors, a hybrid capacitor, or the like.

In use, the memory elements 206 may occasionally experience a power loss or power interruption event. In such cases, the ESM 212 provides power to the memory elements 206 long enough for the second control circuit 208 to copy relevant portions of the memory elements 206 into the non-volatile memory elements 210. In practice, the memory elements 206 and 210 may have a life expectancy that is greater than the life expectancy of the ESM 212. Conventional approaches to this issue require the replacement of the entirety of the memory device 108 when the ESM 212 fails. Such an approach can be expensive and wasteful to the extent that the memory elements 206 and 210 are still viable and are disposed of with a small probability of reuse or recycling.

Exemplary aspects of the present disclosure contemplate providing an ESM that is positioned on a selectively detachable portion of a memory device such that in the event of ESM failure, the ESM may be detached and replaced while the memory elements in the memory device are retained. In specifically contemplated aspects, the primary portion of the memory device on which the memory elements are positioned may remain installed in a computing device, thus reducing the amount of handling required to replace the ESM.

In this regard, FIG. 3 illustrates a memory device 300 removed from a housing but sized to fit within a housing that has a known form factor such as E3.S, E3.L, enterprise device small form factor (EDSFF) published by the Storage Networking Industry Association (SNIA), or the like. The memory device 300 may include a primary portion 302, which includes a substrate or board 304 on which control circuits 306 and memory elements 308(1)-308(P) are mounted. Additionally, the primary portion 302 may include a connector 310, which may, in an exemplary aspect, be a female receptacle with multiple conductors positioned therein.

With further reference to FIG. 3, the memory device 300 may also include a detachable portion 312 on which an ESM 314 is positioned. The detachable portion 312 may further include a connector 316, which may, in an exemplary aspect, be a male connector configured to be pressure fit within the connector 310 and include conductors that mate with the multiple conductors of the connector 310.

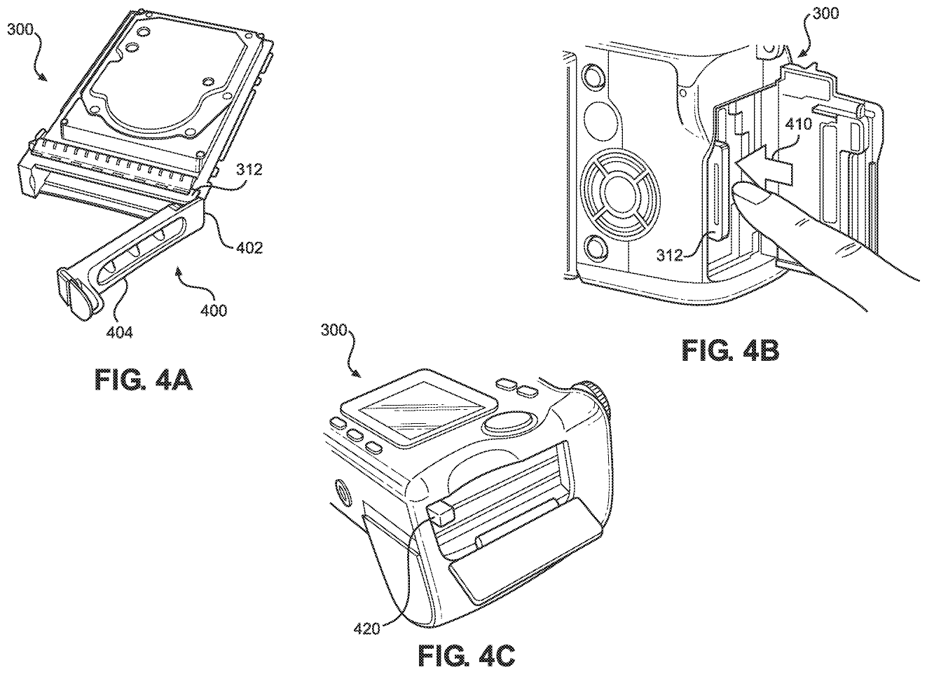

In practice, a face 318 of the memory device 300 may be positioned proximate the face 104 of the computing device 100 such that the detachable portion 312 is readily accessible and able to be removed through the face 104. To assist in such removal, a variety of mechanical levers, springs, or mechanisms may be used. Thus, for example, in FIG. 4A, a hinged lever 400 may be coupled to the detachable portion 312. When a user desires to remove the detachable portion 312, the hinged lever 400 is opened at the hinge 402 and the lever arm 404 is pulled, drawing out the detachable portion 312.

In contrast, FIG. 4B illustrates a spring-loaded mechanism 410 that operates similarly to an SD card in a camera, where pushing against the detachable portion 312 compresses a spring and releases a catch (not shown), such that when the pressure is removed from the detachable portion 312, the spring pushes the detachable portion 312 forward sufficiently far that it may be grasped with fingers and extracted.

As still another option, an ejection button 420 may be provided that operates with an internal lever (not shown) to push the detachable portion 312 up and out of the memory device 300.

While three specific mechanisms are contemplated, other mechanisms may also be used without departing from the present disclosure.

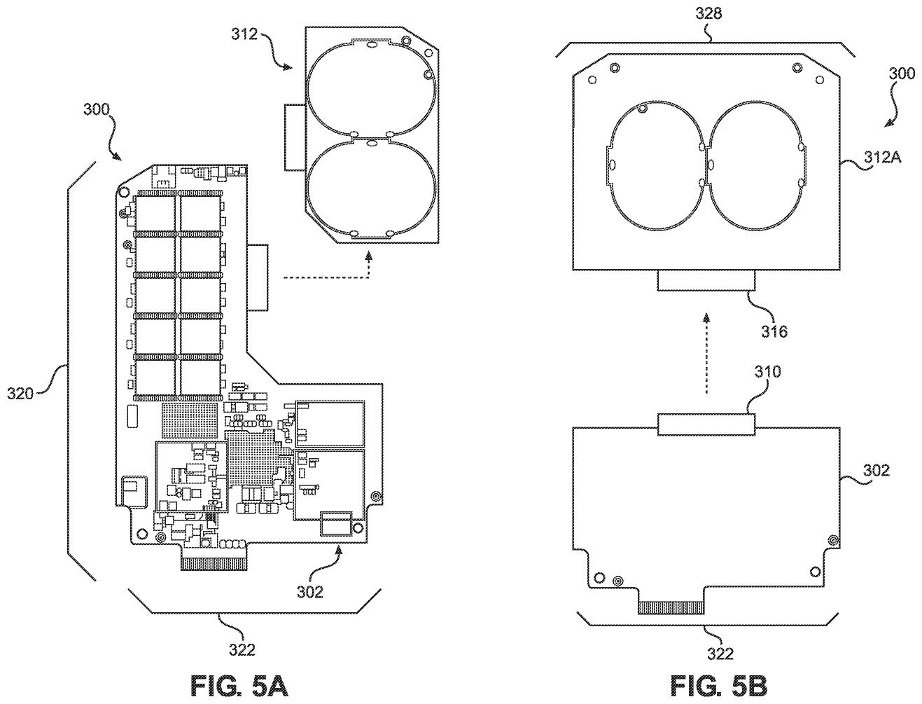

FIGS. 5A and 5B illustrate alternate placements for the removable energy source on a memory device. In particular, instead of having motion along a longitudinal axis 320 of the memory device 300, the detachable portion 312 may move along a lateral axis 322 as shown in FIG. 5A. Likewise, instead of being only a portion of the face 318, the detachable portion 312A may extend along an entirety of the lateral axis 322. The detachable portion 312A may extend between one-fifth to one-half of the length of the memory device 300 along the longitudinal axis 320.

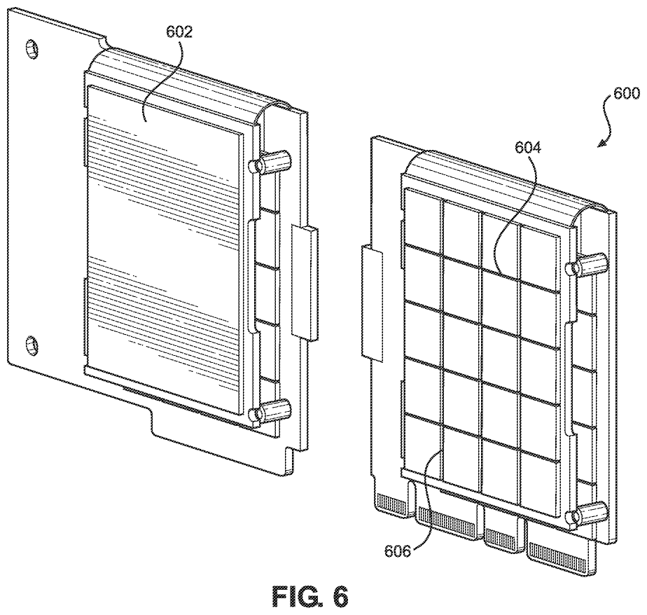

While the above discussion has focused on CXL and specific form factors, the present disclosure is not so limited. For example, an add-in card (AIC) form factor, a graphics card, a peripheral component interconnect (PCI) card, or the like could also benefit from the present disclosure. In this regard, FIG. 6 illustrates an alternate memory device on an AIC 600 that also has a removable energy source 602 that provides power for volatile memory element 604 long enough for data therein to be copied to non-volatile memory element 606 during a power interruption event. Still, other permutations of such cards may also exist.

Note also that there may be additional functionality available in the memory devices of the present disclosure. For example, a light-emitting diode or a plurality of LEDs may be present to provide health information about the memory device (e.g., green or illuminated for healthy, red or not illuminated for a failing energy source, or the like). Temperature or the like may also be indicated as needed or desired.

It should be appreciated that devices using aspects of the present disclosure may allow the ESM to be removed and replaced without disrupting the overall operation of the computing device because the volatile memory is still present and active for the host of the computing device. However, the absence of the ESM while it is being replaced may be of interest to the host for several reasons, including notification of a management agent or application that the memory contents are no longer protected from a power outage. The host may use this information in any manner of ways, non-limiting examples being that the host uses other means to backup important data, or a pre-emptive backup command may be issued by the host to the memory device (and more specifically to the memory controller) while power is still stable and before an unplanned power interruption so as to minimize lost data until the ESM is replaced.

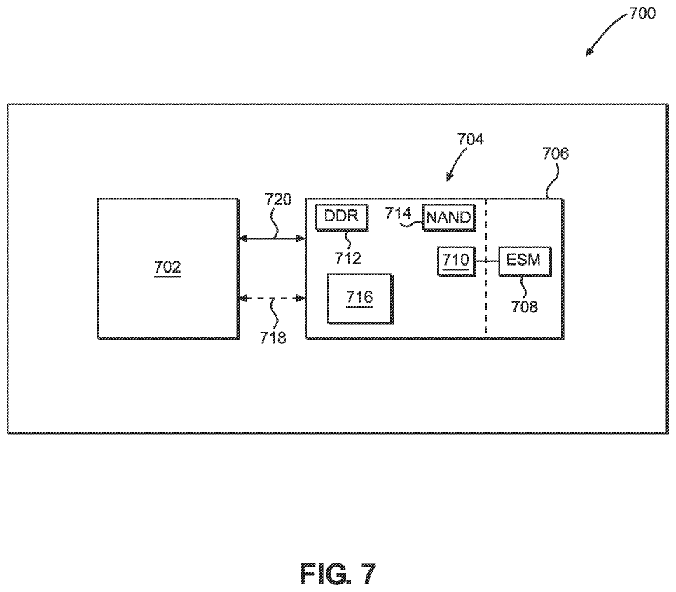

In this regard, FIG. 7 illustrates a computing system 700 with a host 702, which may be a microprocessor or the like. The host 702 is coupled to a memory device 704 (which may be a memory device 300) with a detachable portion 706 having an ESM 708 thereon. A backup memory controller 710 may communicate with the ESM 708 and detect when the detachable portion 706 is removed. The backup memory controller 710 may also operate to back up data in volatile memory 712 into non-volatile memory 714. The backup memory controller 710 may also communicate with a control circuit 716 about the presence or absence of the detachable portion 706. The control circuit 716 may provide this information to the host 702 either through a side band channel 718 or embedded in a command-and-control channel (or the like) on the communication bus 720 (e.g., over the CXL bus).

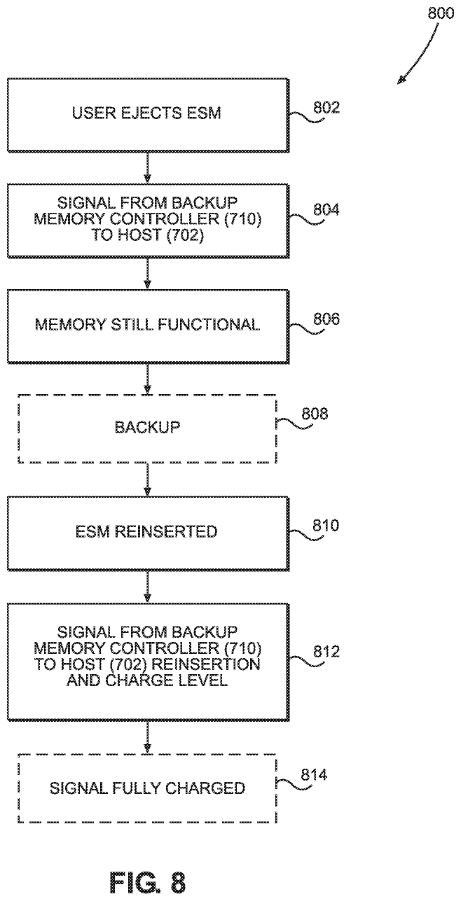

A process 800 for using the detachable ESM 706 of the present disclosure is provided with reference to FIG. 8. The process 800 begins when a user ejects the ESM (block 802), such as by pulling the lever arm 404, pressing the button 420, or using the push/release mechanism of FIG. 4B. This action is detected, for example, by the backup memory controller 710 and causes a signal from the backup memory controller 710 to be sent to the host 702 (block 804). This signal may be in-band signaling, out-of-band signaling on a sideband channel, or the like. Likewise, the detection may be by the control circuit 716 directly or the like. In another aspect, the user may first notify the host using other means (e.g., software management utilities) before ejecting the ESM 802 to let the host know in advance an ejection of the ESM will occur so the host is ready for the removal. Such user notification may be similar to ejecting a USB drive or the like. In either case, it is beneficial for the host to know that the ESM has been ejected.

With continued reference to FIG. 8, the memory 712 is still functional (block 806) and may be written to and read from. However, the memory 712 may be vulnerable in the event of a power loss as no emergency backup may be performed while the ESM is ejected. Accordingly, the host 702 may order a backup (block 808) using normal power instead of the ESM. At some point, the ESM is reinserted (block 810). This reinsertion is detected, such as by the backup memory controller 710, and a signal is sent to the host 702 indicating the reinsertion and a charge level of the ESM (block 812). For example, a new battery may not be fully charged on reinsertion and may be charged. If charging is required, the backup memory controller 710 may provide a subsequent signal that the ESM is fully charged (block 814).

Those of skill in the art will further appreciate that the various illustrative logical blocks, modules, circuits, and algorithms described in connection with the aspects disclosed herein may be implemented as electronic hardware, instructions stored in memory or in another computer-readable medium wherein any such instructions are executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. A memory device comprising:
a housing;
a primary portion positioned within the housing, the primary portion comprising at least one memory element; and
a detachable portion selectively coupled to the primary portion, and when coupled to the primary portion, the detachable portion is positioned within the housing, and when the detachable portion is detached from the primary portion, the detachable portion may be removed from the housing.

2. The memory device of claim 1, further comprising an energy source module (ESM) positioned on the detachable portion.

3. The memory device of claim 2, wherein the ESM comprises a battery.

4. The memory device of claim 2, wherein the primary portion comprises a first connector and the detachable portion comprises a second connector, the first connector, and the second connector configured to mate and form electrical connections therethrough.

5. The memory device of claim 4, wherein the primary portion is L-shaped, and the detachable portion is shaped to fit within an angle of the L.

6. The memory device of claim 5, wherein the first connector is on a short side of the L.

7. The memory device of claim 5, wherein the first connector is on a long side of the L.

8. The memory device of claim 2, wherein the housing comprises a face through which the detachable portion may be removed.

9. The memory device of claim 8, wherein the primary portion extends across part of a lateral axis of the face.

10. The memory device of claim 8, wherein the detachable portion extends across substantially all of a lateral axis of the face and extends across part of a longitudinal axis of the housing.

11. The memory device of claim 2, further comprising a lever coupled to the detachable portion, wherein the lever is configured to open and provide a handle with which to detach the detachable portion from the primary portion.

12. The memory device of claim 2, further comprising a spring mechanism to eject the detachable portion.

13. The memory device of claim 2, further comprising a button coupled to a lever configured to push the detachable portion out of the housing.

14. The memory device of claim 2, further comprising a light-emitting diode (LED) coupled to the ESM and configured to provide an indication of ESM health.

15. The memory device of claim 2, wherein the ESM comprises either a capacitor or a hybrid capacitor.

16. A computing device comprising:
a computer housing delimiting one or more bays on a first face;
a memory device comprising:
a memory housing configured to comply with a published form factor and fit within the one or more bays;
a primary portion positioned within the memory housing, the primary portion comprising at least one memory element; and
a detachable portion selectively coupled to the primary portion and when coupled to the primary portion, the detachable portion is positioned within the memory housing and when the detachable portion is detached from the primary portion, the detachable portion may be removed from the memory housing.

17. A method of manipulating a memory device, comprising:
detecting removal of an energy source module (ESM) from a memory device;
reporting removal to a remote location; and
continuing operation of volatile memory while the ESM is removed.

18. The method of claim 17, wherein reporting the removal comprises reporting removal to a host.

19. The method of claim 17, further comprising detecting insertion of a second ESM.

20. The method of claim 19, further comprising reporting the insertion.
